(19) United States
(12) Patent Application Publication
(10) Pub. No.: US 2010/0039901 A1
(43) Pub. Date: Feb. 18, 2010

(54) ELECTRONIC DEVICE CAPABLE OF SELF-CLOCK ADJUSTMENT AND METHOD THEREOF

(75) Inventor: KUANG-JEN LIU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/503,855

(22) Filed: Jul. 16, 2009

(30) Foreign Application Priority Data
Aug. 15, 2008 (CN) 200810303872.X

(51) Int. Cl. G04C 11/02

(52) U.S. Cl. 368/47

(57) ABSTRACT

An electronic device includes a clock module for providing time information, a communication module, and a time adjustment module. The broadcast module receives and decodes broadcast radio signals. The time adjustment module extracts correct time information from the decoded broadcast radio signals, and adjusts the time information of the clock module according to the correct time information. The invention also provides a time adjustment method applied in the electronic device.

### BACKGROUND

1. Technical Field

The disclosure relates to electronic devices and, particularly, to an electronic device capable of adjusting its clock and a method thereof.

2. Description of Related Art

Many electronic devices display clock information using a clock circuit. However, the clock circuit is often not precise and the clock can deviate from the correct time. Further, if the electronic device has not been powered on for a certain period, such as, a battery has been removed, the clock circuit will cease functioning due to lack of power supply. Providing a dedicated battery to power the clock circuit resolves the second problem but not the first. Furthermore, addition of the dedicated battery, by necessity, increases volume of the electronic device

Therefore, it is desirable to provide an electronic device and method to overcome the described limitations.

### BRIEF DESCRIPTION OF THE DRAWINGS

The components in the drawings are not necessarily drawn to scale, the emphasis instead being placed upon clearly illustrating the principles of the electronic device. Moreover, in the drawings, like reference numerals designate corresponding parts throughout the several views.

FIG. 1 is a block diagram of an electronic device capable of self-clock adjustment, in accordance with an exemplary embodiment.

FIG. 2 is a flowchart illustrating an exemplary method of automatic clock adjustment in accordance with an exemplary embodiment.

### DETAILED DESCRIPTION

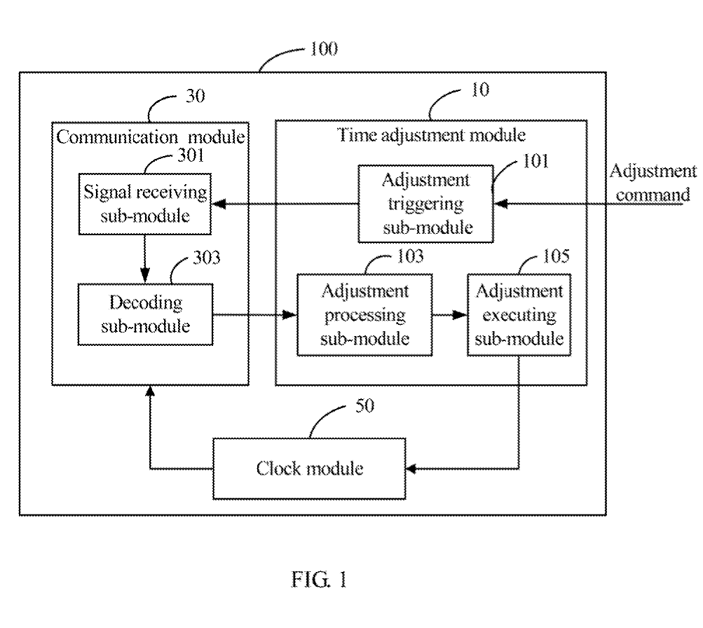

Referring to FIG. 1, an electronic device 100, includes a time adjustment module 10, a communication module 30, and a clock module 50.

The clock module 50 is configured to generate time information. The time adjustment module 10 is configured to generate a trigger signal when receiving an adjustment command. The communication module 30 is configured to receive broadcast radio signals and extract correct time information therefrom when receiving the trigger signal. The time adjustment module 10 is also configured to adjust the time information of the clock module 50 according to the extracted correct time information.

In detail, the time adjustment module 10 includes an adjustment triggering sub-module 101, an adjustment processing sub-module 103, and an adjustment executing sub-module 105; and the communication module 30 includes a signal receiving sub-module 301, and a decoding sub-module 303.

The adjustment triggering sub-module 101 generates a trigger signal according to an adjustment command. In an exemplary embodiment, the adjustment command is generated by an input unit (not shown) of the electronic device 100 in response to input and transmitted to the adjustment triggering sub-module 101, for example, the adjustment command can be input via a keypad (not shown) of the electronic device 100. In another exemplary embodiment, the adjustment command is generated by a processing unit (not shown) according to a preset rule, for example, initiating adjustment of the clock module 50 every hour, whereby the adjustment command is generated every hour and, correspondingly, the trigger signal is generated by the adjustment triggering sub-module 101 every hour. The signal receiving sub-module 301 is configured to receive broadcast radio signals when receiving the trigger signal. The broadcast radio signal is provided by a broadcasting station, which can be chosen as default signal source. The decoding sub-module 303 is configured to decode the broadcast radio signals. As is known, most broadcast radio signals are in digital format and carry information including channel ID, program, correct time information, and others, and the decoding sub-module 303 decodes the broadcast radio signals and obtains the information including the correct time information.

The adjustment processing sub-module 103 is configured to extract the correct time information from the decoded information. The adjustment executing sub-module 105 is configured to adjust the time information of the clock module 50 according to the correct time information. The adjustment executing sub-module 105 is also configured to generate a stop signal after it has adjusted the time information of the clock module 50, the communication module 30 shuts down when receiving the stop signal, for example, the communication module 30 stops receiving broadcast radio signals when receiving the stop signal. Operating power is thus conserved.

The electronic device 100 is thus capable of correcting time information of the clock module 50 by extracting the correct time information from broadcast radio signals.

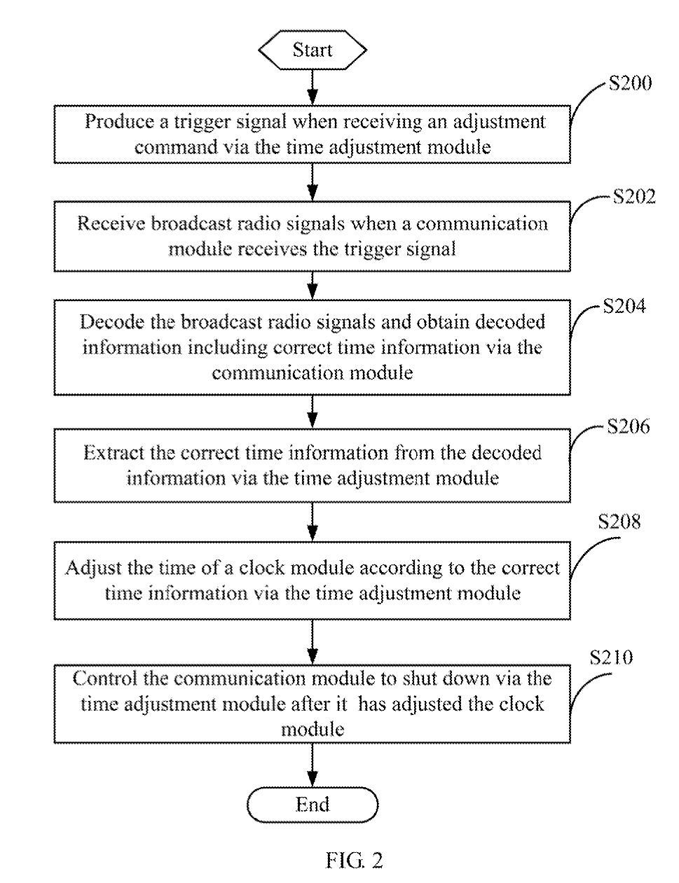

FIG. 2 is a flowchart of a method of automatic clock adjustment. In step S200, the adjustment triggering sub-module 101 generates a trigger signal when receiving an adjustment command.

In step S202, the signal receiving sub-module 301 is activated to receive broadcast radio signals when receiving the trigger signal.

In step S204, the decoding sub-module 303 decodes the broadcast radio signals and obtains information including channel ID, programs, correct time information, and others.

In step S206, the adjustment processing sub-module 103 extracts the correct time information from the decoded information.

In step S208, the adjustment executing sub-module 105 adjusts the time information of the clock module 50 according to the correct time information.

In step S210, the adjustment executing sub-module 105 generates a stop signal and stops the communication module 30 after it has adjusted the time information of the clock module 50.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the present disclosure.

What is claimed is:

1. An electronic device, comprising:
a clock module configured for providing time information;
a communication module configured for receiving and decoding broadcast radio signals containing time information; and
a time adjustment module configured for extracting correct time information carried by the decoded broadcast radio signals and adjusting the time information of the clock module according to the extracted correct time information.

2. The electronic device of claim 1, wherein the time adjustment module is further configured for producing a trigger signal according to an adjustment command to control the communication module to receive the broadcast radio signals.

3. The electronic device of claim 2, wherein the adjustment command is generated by an input unit of the electronic device in response to input and transmitted to the time adjustment module.

4. The electronic device of claim 2, wherein the adjustment command is generated by a processing unit according to a preset rule.

5. The electronic device of claim 4, wherein the preset rule comprises a command for time information of the clock module to be adjusted every a predetermined time interval.

6. The electronic device of claim 2, wherein the communication module is activated to receive the broadcast radio signals upon receiving the trigger signal.

7. The electronic device of claim 6, wherein the time adjustment module is further configured for producing a stop signal after it has adjusted the time information of the clock module, whereby the communication module shuts down when receiving the stop signal.

8. The electronic device of claim 1, wherein the broadcast radio signals are sent by a default broadcasting station.

9. A method for adjusting a clock of an electronic device, the electronic device comprising a clock module, a time adjustment module and a communication module, the method comprising:
producing a trigger signal by the time adjustment module according to an adjustment command;
receiving broadcast radio signals when the communication module receives the trigger signal from the time adjustment module;
decoding the broadcast radio signals via the communication module;
extracting correct time information carried by the decoded broadcast radio signals via the time adjustment module; and
adjusting the time information of the clock module according to the correct time information via the time adjustment module.

10. The method of claim 9, further comprising:
producing a stop signal via the time adjustment module after the time adjustment module has adjusted the time information of the clock module; and
stopping receiving the broadcast radio signals when the communication module receives the stop signal.

11. The method of claim 9, wherein the adjustment command is generated by an input unit of the electronic device in response to user operations.

12. The method of claim 9, wherein the adjustment command is generated by a processing unit according to a preset rule.

13. The method of claim 12, wherein the preset rule comprises a command for time information of the clock module to be adjusted every a predetermined time interval.

14. The method of claim 9, wherein the broadcast radio signals are sent by a default broadcasting station.
